(19) United States
(12) Patent Application Publication
(10) Pub. No.: US 2026/0086397 A1
(43) Pub. Date: Mar. 26, 2026

(54) OPTICAL WAVEGUIDE ELEMENT, OPTICAL MODULATOR, AND OPTICAL TRANSMISSION APPARATUS

(71) Applicant: SUMITOMO OSAKA CEMENT CO., LTD., Tokyo (JP)

(72) Inventor: Kosuke Okahashi, Tokyo (JP)

(73) Assignee: SUMITOMO OSAKA CEMENT CO., LTD., Tokyo (JP)

(21) Appl. No.: 19/312,282

(22) Filed: Aug. 27, 2025

(30) Foreign Application Priority Data
Sep. 26, 2024 (JP) 2024-167442

(51) Int. Cl. G02F 1/035

(52) U.S. Cl. CPC G02F 1/035

(57) ABSTRACT

An optical waveguide element 1 according to the disclosure includes: a substrate 10 including electro-optic crystal and forming an optical waveguide 80; an electrode 60 placed on the substrate 10; an electrode underlayer 50 disposed in contact with a lower surface of the electrode 60; and an oxygen deficiency prevention layer 40 disposed in contact with at least a part of a lower surface of the electrode underlayer 50 and at least a part of an upper surface (substrate upper surface 10a) of the substrate 10, and preventing oxygen deficiency of the substrate 10.

### CROSS-REFERENCE TO RELATED APPLICATION

This application claims the priority benefit of Japanese application serial no. 2024-167442, filed on Sep. 26, 2024. The entirety of the above-mentioned patent application is hereby incorporated by reference herein and made a part of this specification.

### TECHNICAL FIELD

The disclosure relates to an optical waveguide element having an optical waveguide formed thereon, an optical modulator including the optical waveguide element, and an optical transmission apparatus including the optical modulator.

### BACKGROUND

Optical waveguide elements configured to include a substrate having an optical waveguide formed thereon have been utilized in the fields of optical measurement technology and optical communication technology. Substrates composed of a material having an electro-optic effect, such as lithium niobate (LiNbO₃: hereinafter also referred to as LN), have been used for the optical waveguide elements of optical modulators. In recent years, advances in substrate processing technology have enabled the thinning of substrates, and research and development toward miniaturization and high density of optical waveguide elements are progressing.

The following Patent Document 1 (Japanese Patent Application Laid-Open No. 2000-147444) discloses an optical waveguide device capable of achieving matching between a modulation signal applied to an electrode and impedance matching by forming a thin-walled portion in the portion where the electrode is located, forming a buffer layer between the substrate and the electrode, and adjusting the thickness of the thin-walled portion.

The following Patent Document 2 (Japanese Patent Application Laid-Open No. H5-257105) discloses an optical waveguide device that includes an optical waveguide formed within the surface of an electro-optic crystal substrate, a buffer layer formed on the optical waveguide, and a drive electrode formed on the buffer layer, and uses, as the material of the buffer layer, a mixture of silicon oxide and at least one oxide of one or more elements selected from metal elements of groups III to VIII, Ib, and IIb of the periodic table and semiconductor elements excluding silicon, or a transparent insulator of an oxide of silicon and one or more elements selected from metal elements and semiconductor elements, thereby enabling improvement of DC drift characteristics over a long period of time.

The following Patent Document 3 (Japanese Patent Application Laid-Open No. 2012-53487) discloses an optical device capable of reducing optical scattering loss due to roughness of the upper surface and side surfaces of an optical waveguide by forming a rib-type optical waveguide on a substrate and disposing a buffer layer using SiO₂ over the entire surface of the substrate including the optical waveguide.

The following Patent Document 4 (Japanese Patent Application Laid-Open No. 2024-107822) discloses an optical waveguide element that has an optical waveguide formed on a substrate, with electrodes disposed to sandwich the optical waveguide and a dielectric layer disposed to cover the optical waveguide, thereby enabling suppression of optical scattering loss due to roughness of the surface of the optical waveguide and optical absorption loss due to the electrodes, etc., and mitigation of stress caused by the dielectric layer covering the optical waveguide.

The following Patent Document 5 (Japanese Patent Application Laid-Open No. 2019-174733) discloses an optical element capable of suppressing DC drift in an optical element having a substrate formed by lithium niobate crystal and an electrode disposed on the substrate, by using, as a contact metal disposed on the surface in contact with the electrode side, a metal material whose standard enthalpy of formation per coordination bond according to oxidation is greater than the standard enthalpy of formation per coordination bond of niobium pentoxide. The adhesion between the substrate material (for example, LN) and the electrode material (for example, gold) is poor, and peeling of the electrode can be suppressed by interposing a contact metal layer, but it is possible to suppress the occurrence of DC drift by using a metal material that suppresses removal of oxygen from the substrate as the material constituting the contact metal layer.

According to the technology disclosed in Patent Document 1, the buffer layer is formed between the substrate and the electrode, and the electrode is placed on the buffer layer. However, since the adhesion between the electrode and the buffer layer is not necessarily high, there is a problem that the electrode tends to peel off from the buffer layer.

According to the technology disclosed in Patent Document 2, a mixture of silicon oxide and a specific oxide, or a transparent insulator composed of silicon and an oxide is used as the buffer layer disposed between the substrate and the electrode, to achieve improvement of DC drift. However, it is necessary to additionally provide a process for manufacturing such a specific mixture or oxide, and it is not easy to compose the transparent insulator with a uniform mixture or compound, which may cause the characteristics of the optical waveguide device to become unstable.

According to the technology disclosed in Patent Document 3, for example, as shown in FIG. 7, a buffer layer 903 composed of SiO₂ is disposed on the entire surface of a substrate 901 including a rib portion 902 that forms a rib-type optical waveguide. In the example shown here, electrodes 904 are disposed to sandwich the rib portion 902. However, in this configuration, as schematically shown in FIG. 7, when an electric field is applied to the rib-type optical waveguide, carriers 905 in the buffer layer 903 move in a direction that cancels the electric field, resulting in the problem that DC drift occurs.

According to the technology disclosed in Patent Document 4, for example, as shown in FIG. 8, in a substrate 911 having a rib portion 912 that forms a rib-type optical waveguide, a dielectric layer 913 is disposed to cover the rib portion 912 and partially cover the surface of electrodes 914 disposed to sandwich the rib portion 912. However, in this configuration, as schematically shown in FIG. 8, the entire lower surfaces of the electrodes 914 are in direct contact with the substrate 911. As a result, the metal constituting the electrodes 914 takes in oxygen from the substrate 911 and causes oxygen deficiency of the substrate 911. When an electric field is applied to the rib-type optical waveguide, carriers 915 in the substrate 911 may move in a direction that cancels the electric field, potentially causing DC drift. In addition, similar to the technology disclosed in Patent Document 3, when an electric field is applied to the rib-type optical waveguide, carriers 915 in the dielectric layer 913 move in a direction that cancels the electric field, potentially causing DC drift.

According to the technology disclosed in Patent Document 5, in a configuration in which electrodes are placed on a substrate having a rib portion that forms a rib-type optical waveguide, a contact metal layer composed of a metal material that suppresses oxygen from being removed from the substrate is disposed between the substrate and the electrodes. However, for this configuration, it is necessary to consider conditions based on the standard enthalpy of formation of niobium pentoxide and adhesion (adhesiveness) with the substrate, which results in the problem that there are limited metal materials to be selected as the material for the contact metal layer. Furthermore, Patent Document 5 exemplifies that the spacing between electrodes is 15 μm or 25 μm, and in the case of narrowing the spacing between electrodes (for example, 10 μm or less) to achieve miniaturization and high density of optical waveguide elements, the influence of optical absorption caused by the contact metal layer may become significant.

The disclosure provides an optical waveguide element capable of suppressing the occurrence of DC drift due to oxygen deficiency of a substrate, an optical modulator including the optical waveguide element, and an optical transmission apparatus including the optical modulator.

### SUMMARY

The optical waveguide element, the optical modulator, and the optical transmission apparatus according to the disclosure have the following technical features.

An optical waveguide element according to the disclosure includes: a substrate including electro-optic crystal and forming an optical waveguide; an electrode placed on the substrate; an electrode underlayer disposed in contact with a lower surface of the electrode; and an oxygen deficiency prevention layer disposed in contact with at least a part of a lower surface of the electrode underlayer and at least a part of an upper surface of the substrate, and preventing oxygen deficiency of the substrate due to the electrode underlayer.

According to the above configuration, the oxygen deficiency prevention layer interposed between the electrode underlayer, which is disposed in contact with the lower surface of the electrode, and the substrate separates the electrode underlayer and the substrate from directly contacting each other at least in part. By disposing the oxygen deficiency prevention layer between the electrode underlayer and the substrate in this manner, it is possible to prevent oxygen of the substrate from being removed by the electrode underlayer and the electrode disposed above the substrate, and suppress the occurrence of DC drift due to oxygen deficiency of the substrate.

In the optical waveguide element according to the disclosure, in the above configuration, the oxygen deficiency prevention layer may be disposed in contact with an entire surface of the lower surface of the electrode underlayer.

According to the above configuration, by disposing the oxygen deficiency prevention layer 40 to prevent the entire lower surface of the electrode underlayer 50 from directly contacting the substrate 10, it is possible to more reliably prevent oxygen of the substrate from being removed by the electrode underlayer and the electrode disposed above the substrate, and more reliably suppress the occurrence of DC drift due to oxygen deficiency of the substrate.

In the optical waveguide element according to the disclosure, in the above configuration, the oxygen deficiency prevention layer may be disposed below a DC electrode that applies a DC voltage.

According to the above configuration, by disposing the oxygen deficiency prevention layer below the DC electrode, it is possible to efficiently suppress the occurrence of DC drift due to oxygen deficiency of the substrate.

In the optical waveguide element according to the disclosure, in the above configuration, the oxygen deficiency prevention layer may be disposed below the electrode having a thickness of 1.0 μm or less.

According to the above configuration, by disposing the oxygen deficiency prevention layer below the electrode having a thickness of 1.0 μm or less and disposed in the vicinity of the modulation portion (active portion) of the optical waveguide 80, it is possible to efficiently suppress the occurrence of DC drift due to oxygen deficiency of the substrate.

In the above configuration, the optical waveguide element according to the disclosure may include a reinforcing substrate bonded below the substrate via a bonding layer. The substrate may include an LN substrate having a thickness of 1.0 μm or less, and a ridge portion used as the optical waveguide may be formed on the upper surface of the substrate.

According to the above configuration, using an LN thin plate that uses the ridge portion as the optical waveguide as the substrate makes it possible to achieve miniaturization and high density of the optical waveguide element.

In the optical waveguide element according to the disclosure, in the above configuration, the oxygen deficiency prevention layer may not be formed on a surface of the ridge portion.

According to the above configuration, in the ridge portion where the optical waveguide is formed and an electric field is applied, it is possible to prevent the occurrence of DC drift due to carrier movement in the oxygen deficiency prevention layer.

In the optical waveguide element according to the disclosure, in the above configuration, an arithmetic mean roughness Ra of the surface of the ridge portion may be 5.0 nm or less.

According to the above configuration, it is possible to suppress scattering of light waves by the surface of the ridge portion.

In the optical waveguide element according to the disclosure, in the above configuration, the oxygen deficiency prevention layer may include a material having a refractive index of 1.3 or more and a dielectric constant of 3.0 or more.

According to the above configuration, an appropriate material can be used as the oxygen deficiency prevention layer.

In the optical waveguide element according to the disclosure, in the above configuration, a material constituting the oxygen deficiency prevention layer may be SiO₂, and an average atomic ratio of oxygen to silicon may be greater than 1.9.

According to the above configuration, the oxygen deficiency prevention layer becomes a state sufficiently containing oxygen, and plays a role in preventing removal of oxygen from the substrate, thereby suppressing the occurrence of DC drift due to oxygen deficiency of the substrate.

In the optical waveguide element according to the disclosure, in the above configuration, a content ratio of inert gas in the oxygen deficiency prevention layer may be 1.0 atm % to 3.0 atm %.

According to the above configuration, by setting the content ratio of inert gas in the oxygen deficiency prevention layer to a specific range, it is possible to adjust the strength and film stress of the oxygen deficiency prevention layer in a well-balanced manner.

In the optical waveguide element according to the disclosure, in the above configuration, a thickness of the oxygen deficiency prevention layer may be 10 nm to 200 nm.

According to the above configuration, it is possible to stably perform film formation capable of suppressing the occurrence of DC drift due to carriers in the oxygen deficiency prevention layer.

Further, an optical modulator according to the disclosure includes: the above optical waveguide element; a housing accommodating the optical waveguide element; an input optical fiber connected to an optical input portion of the optical waveguide element; and an output optical fiber connected to an optical output portion of the optical waveguide element.

In the above configuration, the optical modulator according to the disclosure may include, as the electrode, a modulation electrode that modulates light waves propagating through the optical waveguide, and have a signal amplification circuit inside the housing, which amplifies a modulation signal applied to the modulation electrode.

Further, an optical transmission apparatus according to the disclosure includes: the above optical modulator; a light source inputting light waves to the optical modulator; and a signal output circuit outputting the modulation signal.

According to the disclosure, it is possible to provide an optical waveguide element capable of suppressing the occurrence of DC drift due to oxygen deficiency of a substrate, an optical modulator including the optical waveguide element, and an optical transmission apparatus including the optical modulator.

### BRIEF DESCRIPTION OF THE DRAWINGS

FIG. 1 is a plan view showing a configuration example of the entire optical waveguide element in the first to third embodiments of the disclosure.

FIG. 2 is a view showing a cross-section along line A-A of FIG. 1 regarding the optical waveguide element in the first embodiment of the disclosure.

FIG. 3 is a view showing a cross-section along line A-A of FIG. 1 regarding a derivative example of the optical waveguide element in the first embodiment of the disclosure.

FIG. 4 is a view showing a cross-section along line B-B of FIG. 1 regarding the optical waveguide element in the second embodiment of the disclosure.

FIG. 5 is a view showing a cross-section along line B-B of FIG. 1 regarding the optical waveguide element in the third embodiment of the disclosure.

FIG. 6 is a plan view showing the optical modulator and the optical transmission apparatus according to the disclosure.

FIG. 7 is a view for illustrating issues related to the technology disclosed in Patent Document 3.

FIG. 8 is a view for illustrating issues related to the technology disclosed in Patent Document 4.

### DESCRIPTION OF THE EMBODIMENTS

Hereinafter, embodiments of the disclosure will be described with reference to the drawings. The drawings referenced in this specification do not necessarily have accurate scales relative to actual dimensions, and may be partially exaggerated or simplified to schematically show the configuration according to the disclosure. Moreover, the numerical ranges described in this specification are ranges that include upper and lower limits, meaning that any numerical value within the numerical ranges can be selected.

The optical waveguide element according to the disclosure, as exemplified in each embodiment, includes a substrate including electro-optic crystal and forming an optical waveguide, an electrode placed on the substrate, an electrode underlayer disposed in contact with a lower surface of the electrode, and an oxygen deficiency prevention layer disposed in contact with at least a part of a lower surface of the electrode underlayer and at least a part of an upper surface of the substrate, and preventing oxygen deficiency of the substrate due to the electrode underlayer.

### First Embodiment

Hereinafter, the optical waveguide element in the first embodiment of the disclosure will be described.

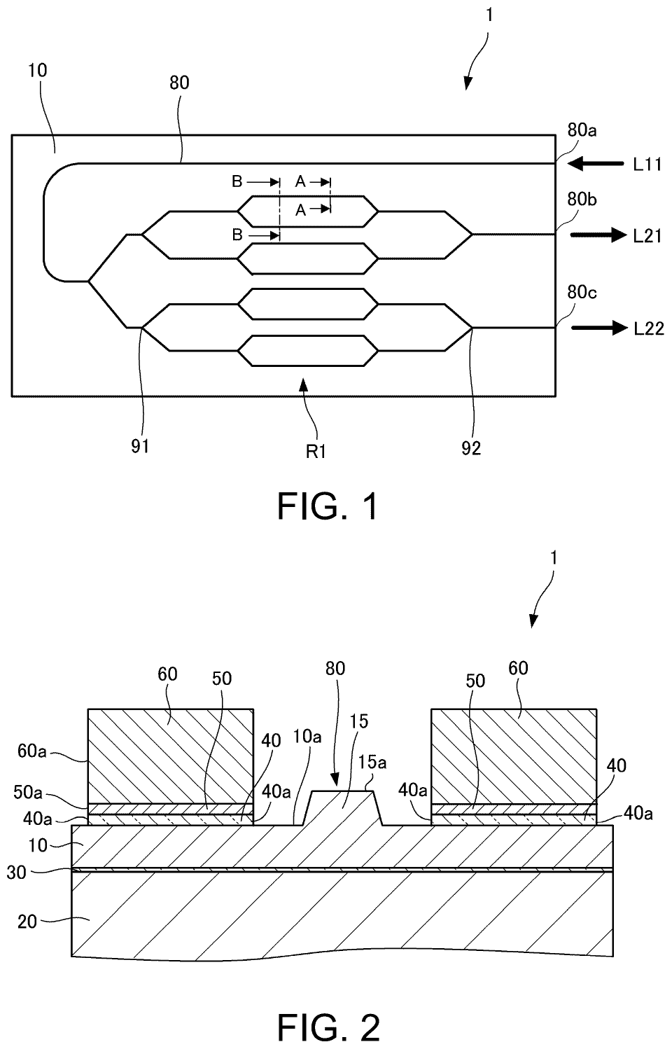

First, the configuration of the entire optical waveguide element 1 in this embodiment will be described with reference to FIG. 1. FIG. 1 is a plan view showing a configuration example of the entire optical waveguide element 1 in this embodiment. Hereinafter, the left-right direction of the plan view shown in FIG. 1 may be referred to as the longitudinal direction of the optical waveguide element 1, and the up-down direction of the plan view shown in FIG. 1 may be referred to as the width direction of the optical waveguide element 1.

FIG. 1 shows the optical waveguide element 1 in which a Mach-Zehnder (MZ)-type optical waveguide is formed on a substrate 10 as an optical waveguide 80. However, the optical waveguide 80 according to the disclosure is not limited to the MZ-type optical waveguide shown in FIG. 1, and is not limited to a Mach-Zehnder type structure. Electrodes 60 (see FIG. 2), etc. are also appropriately disposed on the upper surface of the substrate 10, but are omitted from illustration in FIG. 1.

The MZ-type optical waveguide is a waveguide that includes at least one branching portion 91 and at least one multiplexing portion 92 as basic components. The branching portion 91 is a portion that branches one optical waveguide 80 into two optical waveguides 80. The multiplexing portion 92 is a portion that connects and combines two optical waveguides 80 into one optical waveguide 80. The optical multiplexing/demultiplexing portions such as the branching portion 91 and the multiplexing portion 92 may be manufactured by adjusting the shape, size, and refractive index of the portions constituting the optical waveguide 80, or optical couplers or the like may be disposed. The MZ-type optical waveguide may include two or more branching portions 91 or two or more multiplexing portions 92.

The optical waveguide 80 of the optical waveguide element 1 shown in FIG. 1 is formed to propagate an input light L11 input from an optical input end 80a and output output lights L21 and L22 from two optical output ends 80b and 80c. The optical waveguide 80 extends in the longitudinal direction from the optical input end 80a, is folded back, and is branched into two optical waveguides 80 at the branching portion 91. The two branched optical waveguides 80 are respectively branched into four optical waveguides 80 at the branching portions 91, and are further respectively branched into eight optical waveguides 80 at the branching portions 91. The portion where eight optical waveguides 80 extend in parallel (near region R1 in FIG. 1) is used as a modulation portion (active portion) that modulates light waves propagating through the optical waveguides 80. The eight optical waveguides 80 arranged in parallel are combined into four optical waveguides 80 and further into two optical waveguides 80 at the multiplexing portions 92, and are respectively connected to the two optical output ends 80b and 80c. Accordingly, the input light L11 input from the optical input end 80a is appropriately modulated in the modulation portion, and the output lights L21 and L22 are output from the two optical output ends 80b and 80c.

The optical input end 80a and the optical output ends 80b and 80c, which are end portions of the optical waveguide 80, may be provided with a spot size converter (SSC) or a grading portion that changes the cross-sectional diameter of light waves. The cross-sectional diameter of light waves can be changed. The configuration of the spot size converter or the grading portion is not particularly limited, and can be realized by existing technology.

The cross-sectional structure of the optical waveguide element 1 in this embodiment will be described. FIG. 2 relates to the optical waveguide element 1 in this embodiment, and is a view showing a cross-section along line A-A in FIG. 1. FIG. 2 shows a cross-section orthogonal to the longitudinal direction of the optical waveguide element 1 (a cross-section orthogonal to the light propagation direction in the optical waveguide 80). The left-right direction of the cross-sectional view shown in FIG. 2 corresponds to the width direction of the optical waveguide element 1. Hereinafter, the up-down direction of the cross-sectional view shown in FIG. 2 may be referred to as the height direction of the optical waveguide element 1.

The substrate 10 of the optical waveguide element 1 is made of a material having an electro-optic effect. As the material having an electro-optic effect, lithium niobate (LN), lithium tantalate (LT), lead lanthanum zirconate titanate (PLZT), etc. can be used, and these materials may be doped with MgO or the like. Additionally, vapor-phase growth films of these materials, composite substrates in which these materials are bonded to different substrates, etc. may be used.

The thickness of the substrate 10 is preferably 1.0 μm or less, for example. The thickness of the substrate 10 means the height from the lower surface of the substrate 10 to the flat upper surface (substrate upper surface 10a) where a ridge portion 15 is not formed. By making the substrate 10 a thin plate with a thickness of 1.0 μm or less, reduction of the drive voltage and miniaturization can be achieved.

The optical waveguide 80 is formed on the substrate 10 of the optical waveguide element 1. The ridge portion 15 is formed on the substrate 10 to protrude from the flat substrate upper surface 10a. The ridge portion 15 is provided in a portion corresponding to the optical waveguide 80, and forms a ridge optical waveguide that is a path through which light waves propagate.

The method of forming the ridge optical waveguide is not particularly limited, and for example, the substrate 10 may be etched to form the ridge portion 15 (rib portion), or the ridge portion 15 (ridge portion) may be formed by forming grooves on both sides of the optical waveguide 80. Additionally, in accordance with the ridge optical waveguide, the refractive index may be further increased by diffusing Ti or the like into the surface of the substrate 10 by a thermal diffusion method or a proton exchange method. The size of the ridge portion 15 is not particularly limited, but similar to ordinary ridge optical waveguides, the width and height can be set to approximately 1.0 μm.

In order to increase the mechanical strength of the thinned substrate 10, a reinforcing substrate (support substrate) 20 may be disposed under the substrate 10, as shown in FIG. 2. In FIG. 2, the lower portion of the reinforcing substrate 20 is omitted from illustration. The thickness of the reinforcing substrate 20 is not particularly limited, but can be set to, for example, approximately 0.2 mm to 1.0 mm. The reinforcing substrate 20 may be bonded to the substrate 10 via a bonding layer (intermediate layer) 30, as shown in FIG. 2, or may be directly bonded to the substrate 10. The material of the reinforcing substrate 20 is not particularly limited, but for example, Si, glass, quartz, fused silica, synthetic quartz, alkali glass, alkali-free glass, lead glass, borosilicate glass, soda glass, sapphire, alumina, or the like can be used.

The electrode 60 is placed on the substrate 10. In this embodiment, as shown in FIG. 2, an oxygen deficiency prevention layer 40 is formed according to the arrangement position of the electrode 60. The oxygen deficiency prevention layer 40 can be formed on the upper surface of the substrate 10 (substrate upper surface 10a) by a sputtering method or the like.

The oxygen deficiency prevention layer 40 is disposed between the substrate 10 and an electrode underlayer 50. The oxygen deficiency prevention layer 40 is disposed with the lower surface in contact with the substrate 10 and the upper surface in contact with the electrode underlayer 50. The oxygen deficiency prevention layer 40 interposed between the substrate 10 and the electrode underlayer 50 has a role of preventing oxygen from being removed from the substrate 10 by the electrode underlayer 50 (and further by the electrode 60 on the upper surface side thereof).

For the material of the oxygen deficiency prevention layer 40, a dielectric material having a lower refractive index and higher transparency than the material of the substrate 10 (for example, LN) and the material of the electrode 60 (for example, gold (Au)) can be used. The refractive index of the material of the oxygen deficiency prevention layer 40 is preferably 1.3 or more, and the dielectric constant of the material of the oxygen deficiency prevention layer 40 is preferably 3 or more. Also, it is preferable to select a material having small optical absorption in the wavelength band of light waves propagating through the optical waveguide 80. Specifically, as the material of the oxygen deficiency prevention layer 40, it is preferable to use oxides, fluorides, or nitrides of metal elements of Groups 1 to 17 of the periodic table. For example, SiO₂, Al₂O₃, MgF₂, La₂O₃, ZnO, HfO₂, MgO, CaF₂, Y₂O₃, or the like can be used.

In the case of using SiO₂ as the material of the oxygen deficiency prevention layer 40, it is preferable to set the average atomic ratio O/Si greater than 1.9 (O/Si>1.9). This allows the oxygen deficiency prevention layer 40 to be in a state of sufficiently containing oxygen, and play a role of preventing oxygen from being removed from the substrate 10, thereby enabling suppression of the occurrence of DC drift due to oxygen deficiency of the substrate 10. The average atomic ratio in the oxygen deficiency prevention layer 40 can be detected by Rutherford backscattering analysis (RBS analysis).

The content ratio of inert gas (for example, argon) in the oxygen deficiency prevention layer 40 is preferably 1.0 atm % to 3.0 atm %. The content ratio of inert gas in the oxygen deficiency prevention layer 40 can be detected by Rutherford backscattering analysis (RBS analysis), similar to the average atomic ratio.

In the case of a large amount of inert gas in the oxygen deficiency prevention layer 40, the density of the oxygen deficiency prevention layer 40 becomes low, and sufficient strength may not be obtained. On the other hand, in the case of a small amount of inert gas in the oxygen deficiency prevention layer 40, the density of the oxygen deficiency prevention layer 40 becomes high, and the influence of the film stress of the oxygen deficiency prevention layer 40 on the substrate 10 becomes large, making peeling from the substrate 10 more likely to occur. Therefore, the oxygen deficiency prevention layer 40 can be physically stabilized by controlling the content ratio of inert gas in the oxygen deficiency prevention layer 40 to be within the above range. The content ratio of inert gas in the oxygen deficiency prevention layer 40 can be controlled to be within the above range by appropriately adjusting the pressure of inert gas used during film formation by a sputtering method or the like, the film formation rate, etc.

The thickness of the oxygen deficiency prevention layer 40 is preferably set within a specific range for the following reasons. In the case of the oxygen deficiency prevention layer 40 being too thick, carriers in the oxygen deficiency prevention layer 40 may move due to electric field, and DC drift may occur. Further, in the case of the oxygen deficiency prevention layer 40 being too thick, the influence of the film stress of the oxygen deficiency prevention layer 40 on the substrate 10 becomes large, making peeling from the substrate 10 more likely to occur. Therefore, the thickness of the oxygen deficiency prevention layer 40 is preferably 200 nm or less, and more preferably 100 nm or less. On the other hand, since the oxygen deficiency prevention layer 40 is formed by a sputtering method or the like, control of the film formation thickness becomes difficult in the case of making the thickness too small. From the viewpoint of process stability, the thickness of the oxygen deficiency prevention layer 40 is preferably 10 nm or more, and more preferably 20 nm or more. In other words, the thickness of the oxygen deficiency prevention layer 40 is preferably 10 nm to 200 nm, and more preferably 20 nm to 100 nm.

The oxygen deficiency prevention layer 40 is disposed between the substrate 10 and the electrode underlayer 50, with the lower surface in contact with the substrate 10 and the upper surface in contact with the electrode underlayer 50. The electrode underlayer 50 is interposed between the oxygen deficiency prevention layer 40 and the electrode 60 to function as an adhesive layer, and has a role of enhancing the adhesion (adhesiveness) of the electrode 60 to prevent peeling of the electrode 60.

The material of the electrode underlayer 50 is preferably selected in consideration of adhesion with the substrate 10 and the oxygen deficiency prevention layer 40, and for example, Nb, Ti, Al, Mn, Cr, Ni, Pt, SiN, or the like can be used. The film forming method and thickness of the electrode underlayer 50 are not particularly limited. For example, the thickness of the electrode underlayer 50 may be approximately the same as or less than the thickness of the oxygen deficiency prevention layer 40.

The electrode 60 is used for modulation of light waves propagating through the optical waveguide 80, and is disposed in the vicinity of the optical waveguide 80. As shown in FIG. 2, this embodiment illustrates a case where the electrodes 60 are disposed to sandwich the optical waveguide 80 (X-cut substrate), but the disclosure is also applicable to a case where the electrode 60 is disposed above the optical waveguide 80 (Z-cut substrate). Additionally, in this specification, the configuration of a single electrode structure is mainly illustrated and described, but the disclosure is also applicable to a differential electrode structure. The electrode 60 includes a modulation electrode that applies a modulation signal to the optical waveguide 80, and a DC electrode that applies a DC bias voltage.

The material of the electrode 60 is not particularly limited as long as the material is a metal material with low resistance and excellent impedance characteristics, and Au, Ag, Cu, or the like can be used. The method of forming the electrode 60 is not particularly limited, and a sputtering method, a vapor deposition method, a plating method, or the like can be used according to conventional methods.

In the optical waveguide element 1 according to this embodiment, as described above, the oxygen deficiency prevention layer 40 is formed on the upper surface (substrate upper surface 10a) of the substrate 10 on which the ridge portion 15 is formed, and the electrode 60 is formed on the upper surface of the oxygen deficiency prevention layer 40 via the electrode underlayer 50. That is, the optical waveguide element 1 in this embodiment has a configuration in which the oxygen deficiency prevention layer 40 is disposed on the substrate upper surface 10a, the electrode underlayer 50 is disposed on the upper surface of the oxygen deficiency prevention layer 40, and the electrode 60 is disposed on the upper surface of the electrode underlayer 50.

The oxygen deficiency prevention layer 40 is disposed between the substrate 10 and the electrode underlayer 50. In this embodiment, the oxygen deficiency prevention layer 40 is disposed in contact with the entire lower surface of the electrode underlayer 50, and the upper surface of the substrate 10 and the lower surface of the electrode underlayer 50 are separated by the oxygen deficiency prevention layer 40 so as not to directly contact each other.

The oxygen deficiency prevention layer 40 is made of a material that does not substantially remove oxygen from the substrate 10, and has a role of preventing oxygen from being removed from the substrate 10 by the electrode underlayer 50 and the electrode 60 with the oxygen deficiency prevention layer 40 interposed between the substrate 10 and the electrode underlayer 50 and the electrode 60. Accordingly, the oxygen deficiency prevention layer 40 prevents oxygen from being removed from the substrate 10 by the electrode underlayer 50 and the electrode 60 disposed above the substrate 10, and can suppress the occurrence of DC drift due to oxygen deficiency of the substrate 10.

In this embodiment, the widths of all the stacked oxygen deficiency prevention layer 40, electrode underlayer 50, and electrode 60 are set to be the same. Specifically, as shown in FIG. 2, the oxygen deficiency prevention layer 40 is formed so that a side surface 40a coincides with a side surface 50a of the electrode underlayer 50 and a side surface 60a of the electrode 60, with no film formed between the electrodes 60.

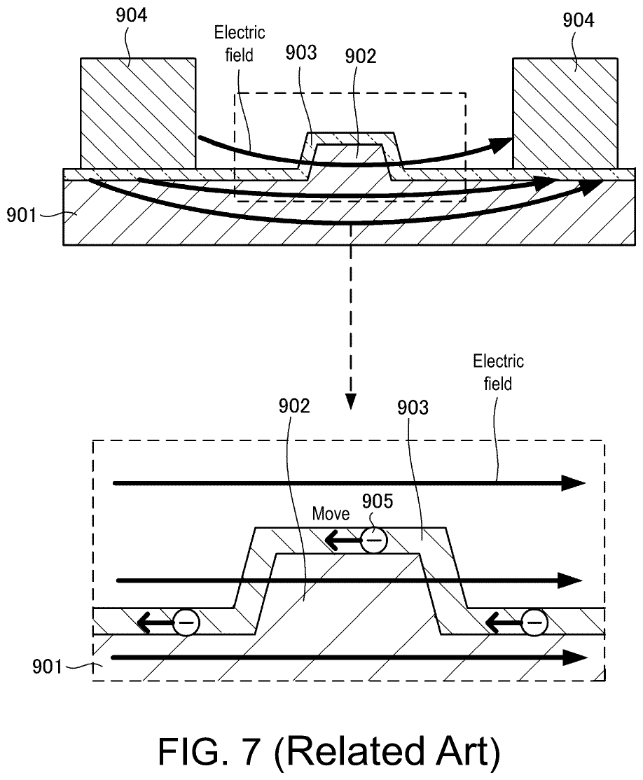

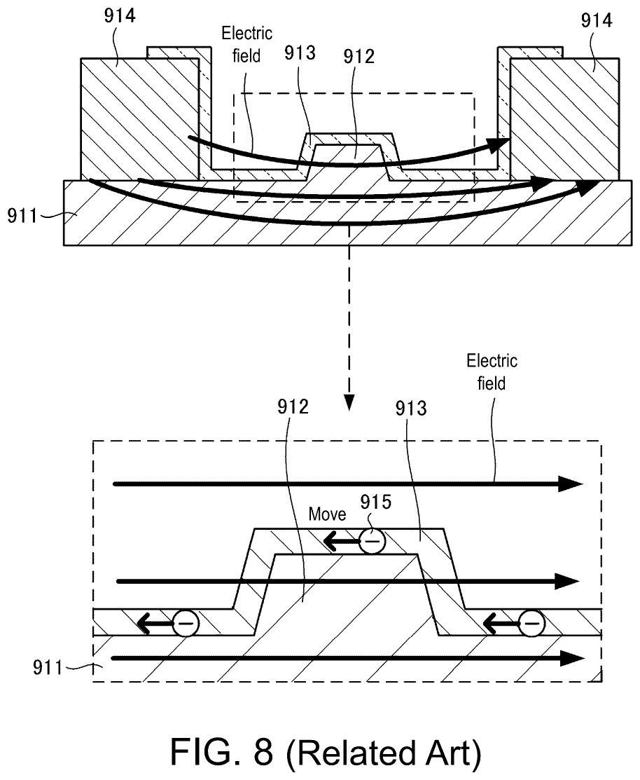

In this embodiment, based on the knowledge that carriers in the film covering the surface 15a of the ridge portion 15 and the substrate upper surface 10a between the electrodes 60 are one factor in the occurrence of DC drift (see, for example, FIG. 7 and FIG. 8), as shown in FIG. 2, the substrate upper surface 10a between the electrodes 60 including the surface 15a of the ridge portion 15 is exposed to air without being covered with a specific material. The surface 15a of the ridge portion 15 means the upper surface and side surfaces of the ridge portion 15 protruding from the substrate upper surface 10a.

In the case of exposing the surface of the ridge portion 15 to air with no specific material covered thereon, in order to suppress scattering of light waves by the surface 15a of the ridge portion 15, the arithmetic mean roughness Ra of the surface 15a of the ridge portion 15 is preferably 5.0 nm or less, and more preferably 3.0 nm or less. The arithmetic mean roughness Ra of the ridge portion 15 can be measured and calculated using an atomic force microscope (AFM). By reducing the roughness of the surface 15a of the ridge portion 15 in this manner, scattering of light waves by the surface 15a of the ridge portion 15 can be suppressed. Accordingly, it is possible to suppress the occurrence of DC drift due to oxygen deficiency of the substrate 10 while suppressing scattering of light waves without forming an optical scattering suppression layer covering the surface 15a of the ridge portion 15.

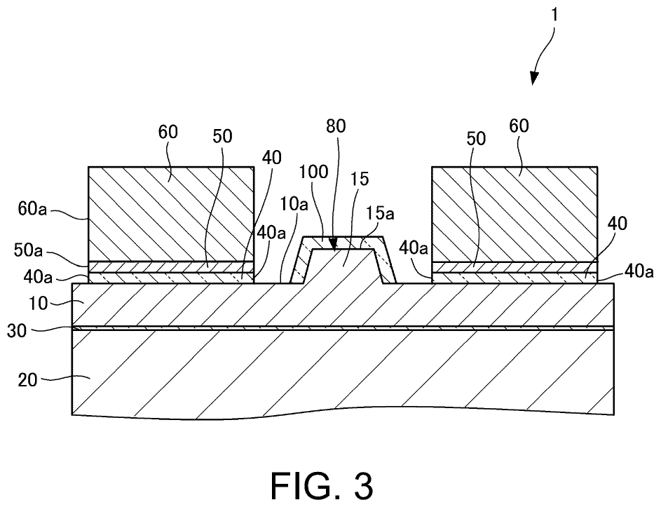

Furthermore, as in the derivative example shown in FIG. 3, an optical scattering suppression layer 100 may be formed to cover the surface 15a of the ridge portion 15. The optical scattering suppression layer 100 has a function of suppressing scattering of light waves by the surface 15a of the ridge portion 15. The optical scattering suppression layer 100 may use, for example, the same material as the oxygen deficiency prevention layer 40, or may be a film in which carrier movement does not occur, such as a photosensitive insulating film (permanent film). Further, a material in which carrier movement does not occur may be filled between the electrodes 60.

As shown in FIG. 3, the optical scattering suppression layer 100 is preferably formed to cover only the surface 15a of the ridge portion 15, and it is preferable that the oxygen deficiency prevention layer 40 disposed below the electrode 60 and the optical scattering suppression layer 100 covering the surface 15a of the ridge portion 15 are separated in the width direction and do not connect to each other. By limiting the arrangement position of the optical scattering suppression layer 100 to only the surface 15a of the ridge portion 15 in this manner, it is possible to appropriately and effectively suppress scattering of light waves by the surface 15a of the ridge portion 15 while minimizing the occurrence of DC drift even in the case of using a material in which carriers move for the optical scattering suppression layer 100.

In FIG. 2, the oxygen deficiency prevention layer 40 is disposed below all the electrodes 60 shown, but the oxygen deficiency prevention layer 40 may be selectively disposed according to the attributes of the electrodes 60.

The oxygen deficiency prevention layer 40 has an effect of suppressing the occurrence of DC drift due to oxygen deficiency of the substrate 10, and is preferably disposed at least below DC electrodes that apply a DC voltage such as DC bias voltage. For this reason, the oxygen deficiency prevention layer 40 may be disposed only below the DC electrodes. In this case, the oxygen deficiency prevention layer 40 may not be disposed below modulation electrodes that apply modulation signals to the optical waveguide 80, or the oxygen deficiency prevention layer 40 may also be disposed below the modulation electrodes.

Additionally, in the modulation portion (active portion) of the optical waveguide 80, in order to prevent oxygen deficiency of the substrate 10, the oxygen deficiency prevention layer 40 may be disposed only below the electrode 60 disposed in the vicinity of the modulation portion (active portion). Specifically, the thickness of the electrode 60 disposed in the vicinity of the modulation portion (active portion) of the optical waveguide 80 is 1.0 μm or less, and the oxygen deficiency prevention layer 40 may be disposed only below the electrode 60 having a thickness of 1.0 μm or less. In this case, the oxygen deficiency prevention layer 40 may not be disposed below the electrode 60 having a thickness exceeding 1.0 μm, or the oxygen deficiency prevention layer 40 may also be disposed below the electrode 60 having a thickness exceeding 1.0 μm.

### Second Embodiment

The second embodiment of the disclosure will be described. The optical waveguide element 1 in the second embodiment is different from the above-described first embodiment in that the width of the oxygen deficiency prevention layer 40 is set to be greater than the widths of the electrode underlayer 50 and the electrode 60. Components having the same functions as in the above-described embodiment are given the same reference numerals with the descriptions simplified or omitted.

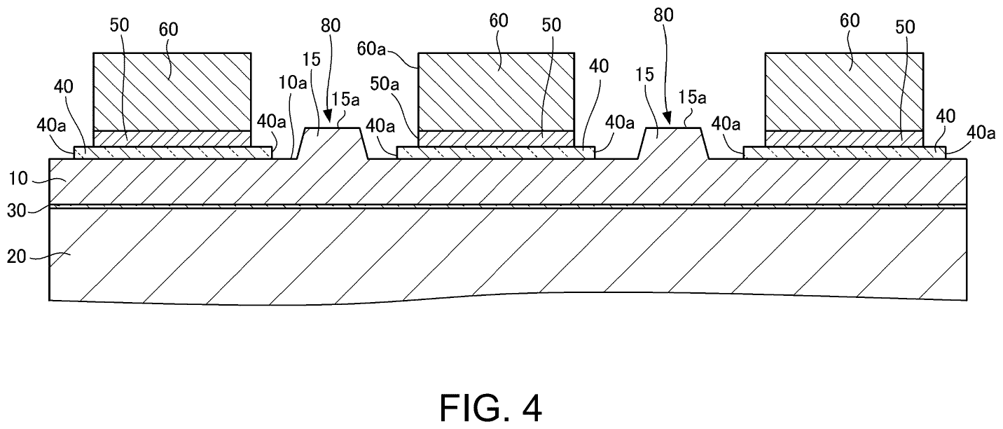

FIG. 4 relates to the optical waveguide element 1 in this embodiment, and is a view showing a cross-section along line B-B in FIG. 1.

The widths of the stacked oxygen deficiency prevention layer 40, electrode underlayer 50, and electrode 60 are not necessarily the same, and as shown in FIG. 4, the width of the oxygen deficiency prevention layer 40 may be set to be greater than the widths of the electrode underlayer 50 and the electrode 60. Specifically, as shown in FIG. 4, the oxygen deficiency prevention layer 40 is formed with the side surface 40a positioned closer to the ridge portion 15 forming the optical waveguide 80 than the side surface 50a of the electrode underlayer 50 and the side surface 60a of the electrode 60. The surface 15a of the ridge portion 15 may be exposed to air, or as shown in FIG. 3, the optical scattering suppression layer 100 may be formed on the surface 15a of the ridge portion 15.

In this embodiment, the oxygen deficiency prevention layer 40 is formed to cover a wider range of the substrate upper surface 10a compared to the above-described first embodiment. By increasing the width of the oxygen deficiency prevention layer 40 disposed between the substrate 10 and the electrode underlayer 50 and the electrode 60 in this manner, alignment tolerance is secured so that even in the case of misalignment of the electrode 60, the oxygen deficiency prevention layer 40 remains at a position that prevents oxygen from being removed from the substrate 10. This makes it possible to more reliably prevent oxygen from being removed from the substrate 10 by the electrode underlayer 50 and the electrode 60, and to more reliably suppress the occurrence of DC drift due to oxygen deficiency of the substrate 10.

### Third Embodiment

The third embodiment of the disclosure will be described. The optical waveguide element 1 in the third embodiment differs from the above-described first and second embodiments in that the width of the oxygen deficiency prevention layer 40 is smaller, and a part of the lower surface of the electrode underlayer 50 is in direct contact with the substrate 10. Components having the same functions as in the above-described embodiments are given the same reference numerals with the descriptions simplified or omitted.

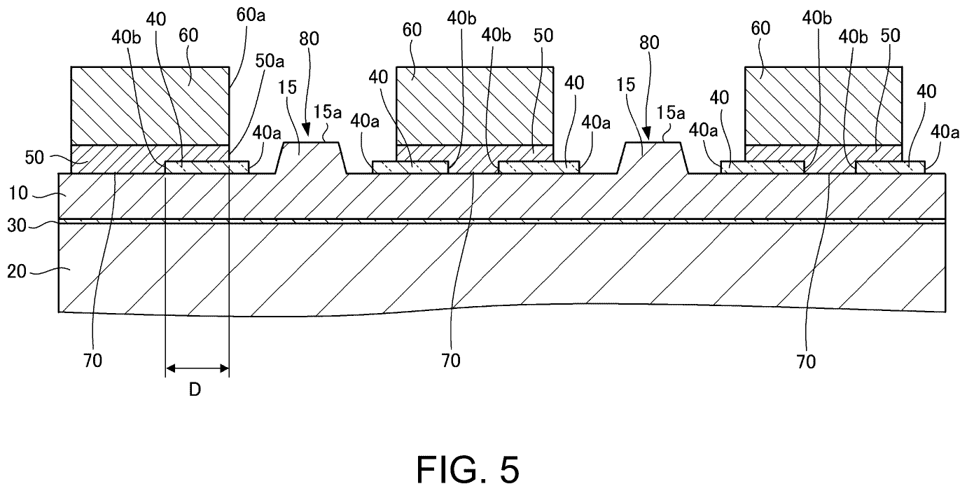

FIG. 5 relates to the optical waveguide element 1 in this embodiment, and is a view showing a cross-section along line B-B in FIG. 1.

The electrode 60 is configured to apply an electric field to the optical waveguide 80 formed in the ridge portion 15. The substrate 10 between the electrodes 60 sandwiching the ridge portion 15 or the substrate 10 close thereto becomes an electric field path, and it is preferable to reliably suppress oxygen deficiency in the substrate 10 of the electric field path, while the oxygen deficiency prevention layer 40 does not necessarily need to be disposed in the substrate 10 at a location away from the electric field path. That is, in this embodiment, while allowing a part of the lower surface of the electrode underlayer 50 to contact the substrate 10, the oxygen deficiency prevention layer 40 is disposed only at a location where there is an effect of suppressing the occurrence of DC drift.

The oxygen deficiency prevention layer 40 can be disposed to be biased toward the ridge portion 15 side where the optical waveguide 80 is formed, and for example, as shown in FIG. 5, one end portion (side surface 40b) positioned at a location away from the ridge portion 15 may be disposed to be positioned inside the electrode underlayer 50 in the width direction. A distance D in the width direction (see FIG. 5) between the side surface 40b of the oxygen deficiency prevention layer 40 positioned at a location away from the ridge portion 15 and the side surface 60a of the electrode 60 is preferably 5.0 μm or more, for example. This makes it possible to prevent oxygen in the substrate 10 from being removed by the electrode underlayer 50 and the electrode 60, and suppress the occurrence of DC drift due to oxygen deficiency of the substrate 10. The surface 15a of the ridge portion 15 may be exposed to air, or as shown in FIG. 3, the optical scattering suppression layer 100 may be formed on the surface 15a of the ridge portion 15.

In the case of the side surface 40b of the oxygen deficiency prevention layer 40 being disposed inside the electrode underlayer 50 in the width direction, the electrode underlayer 50 has a surface in contact with the upper surface of the oxygen deficiency prevention layer 40, and also has a portion that is in direct contact with the substrate 10 (contact surface 70 between the electrode underlayer 50 and the substrate 10) at a location away from the ridge portion 15. The contact surface 70 between the electrode underlayer 50 and the substrate 10 is disposed at a position 5.0 μm or more away from the side surface 60a of the electrode 60. The optical waveguide 80 does not exist on the left side of FIG. 5, and in the electrode 60 on the left side of FIG. 5, the contact surface 70 between the electrode underlayer 50 and the substrate 10 is wider than in other electrodes 60.

The lower surface of the electrode underlayer 50 does not have a flat shape but becomes uneven. The uneven lower surface of the electrode underlayer 50 has an advantage of increasing the contact area with each layer (the substrate 10 and the oxygen deficiency prevention layer 40) on the lower surface side of the electrode underlayer 50, which can improve adhesion by an anchor effect.

Hereinafter, an optical modulator and an optical transmission apparatus according to the disclosure will be described. The disclosure can provide an optical modulator and an optical transmission apparatus utilizing the optical waveguide element 1 in each of the above-described embodiments.

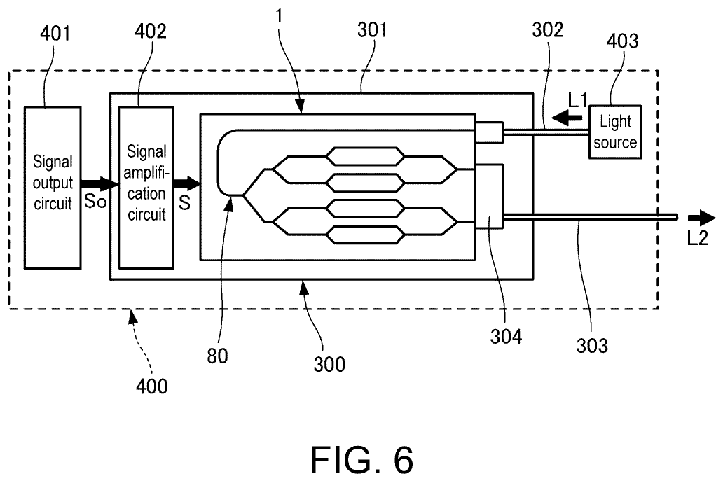

FIG. 6 is a plan view showing an optical modulator 300 and an optical transmission apparatus 400 according to the disclosure. The optical modulator 300 shown in FIG. 6 includes an optical waveguide element 1, a housing 301, an input optical fiber 302, and an output optical fiber 303. The example shown here illustrates a case where the optical waveguide element 1 in this embodiment is applied to a broadband coherent driver modulator (HB-CDM).

In the optical modulator 300, the optical waveguide element 1 is accommodated in the housing 301. The input optical fiber 302 is connected to an optical input portion including the optical input end 80a of the optical waveguide element 1, and the output optical fiber 303 is connected to an optical output portion including the optical output ends 80b and 80c. By connecting the optical waveguide element 1 inside the housing 301 and the outside of the housing 301 with optical fibers in this manner, a compact optical modulator 300 can be provided. A spatial optical system may be interposed between the optical input portion and the input optical fiber 302, and between the optical output portion and the output optical fiber 303. Further, the above-described optical waveguide element 1 has two optical output ends 80b and 80c. In this case, as shown in FIG. 6, the optical modulator 300 includes a polarization combining portion 304, and may be configured to polarization-combine light output from the two optical output ends 80b and 80c, and guide the light to the output optical fiber 303.

As shown in FIG. 6, the optical transmission apparatus 400 can be configured by connecting to the optical modulator 300 a signal output circuit 401 that generates an electrical signal So (modulation signal), which is a high-frequency signal for performing a modulation operation, and a signal amplification circuit 402 that amplifies the electrical signal So to generate an amplified signal S (modulation signal). The signal output circuit 401 and the signal amplification circuit 402 may be disposed outside the housing 301 of the optical modulator 300, but disposing the signal output circuit 401 and the signal amplification circuit 402 inside the housing 301 can achieve efficient transmission of the modulation signal and miniaturization of the optical transmission apparatus 400.

Further, the optical transmission apparatus 400 may be configured to mount a light source 403, and input the light (input light L1) emitted by the light source 403 to the optical input end 80a of the optical waveguide element 1. Thereby, the light output from the light source 403 can be modulated by the optical modulator 300, and the modulated light (output light L2) can be output from the optical transmission apparatus 400.

The optical waveguide element 1 in this embodiment is applicable to various apparatuses related to optical measurement technology and optical communication technology. The optical waveguide element 1 in this embodiment may be mounted inside a transceiver, and may further be mounted in a pluggable module. The pluggable module includes an electrical interface that can be inserted into and removed from an optical transmission apparatus, and an optical interface that can be connected to an optical fiber connector, and enables implementation of a high-performance transceiver function in the optical transmission apparatus.

The optical waveguide element 1 in this embodiment may be mounted in packaged modules such as CPO (Co-Packaged Optics) and NPO (Near Package Optics), and sub-assemblies such as IC-TROSA (Integrated Coherent Transmit-Receive Optical Sub-Assembly) and COSA (Coherent Optical Sub-Assembly). Furthermore, the optical waveguide element 1 can also be incorporated into optical circuits utilizing silicon photonics technology. The optical waveguide element 1 in this embodiment achieves the effect of suppressing the occurrence of DC drift, and can provide excellent operational stability in various devices.

The embodiments described above are provided to facilitate understanding of the disclosure, and are not intended to limit the disclosure. Each component disclosed in the above-described embodiments is intended to include all design changes and equivalents that belong to the technical scope of the disclosure. Moreover, technical ideas obtained by appropriately combining the concepts exemplified in the embodiments are also included in the disclosure.

What is claimed is:

1. An optical waveguide element, comprising:
a substrate comprising electro-optic crystal and forming an optical waveguide;
an electrode placed on the substrate;
an electrode underlayer disposed in contact with a lower surface of the electrode; and
an oxygen deficiency prevention layer disposed in contact with at least a part of a lower surface of the electrode underlayer and at least a part of an upper surface of the substrate, and preventing oxygen deficiency of the substrate due to the electrode underlayer.

2. The optical waveguide element according to claim 1, wherein the oxygen deficiency prevention layer is disposed in contact with an entire surface of the lower surface of the electrode underlayer.

3. The optical waveguide element according to claim 1, wherein the oxygen deficiency prevention layer is disposed below a DC electrode that applies a DC voltage.

4. The optical waveguide element according to claim 1, wherein the oxygen deficiency prevention layer is disposed below the electrode having a thickness of 1.0 μm or less.

5. The optical waveguide element according to claim 1, comprising a reinforcing substrate bonded below the substrate via a bonding layer,
wherein the substrate comprises an LN substrate having a thickness of 1.0 μm or less, and
a ridge portion used as the optical waveguide is formed on the upper surface of the substrate.

6. The optical waveguide element according to claim 5, wherein the oxygen deficiency prevention layer is not formed on a surface of the ridge portion.

7. The optical waveguide element according to claim 5, wherein an arithmetic mean roughness Ra of the surface of the ridge portion is 5.0 nm or less.

8. The optical waveguide element according to claim 1, wherein the oxygen deficiency prevention layer comprises a material having a refractive index of 1.3 or more and a dielectric constant of 3.0 or more.

9. The optical waveguide element according to claim 1, wherein a material constituting the oxygen deficiency prevention layer is SiO₂, and an average atomic ratio of oxygen to silicon is greater than 1.9.

10. The optical waveguide element according to claim 1, wherein a content ratio of inert gas in the oxygen deficiency prevention layer is 1.0 atm % to 3.0 atm %.

11. The optical waveguide element according to claim 1, wherein a thickness of the oxygen deficiency prevention layer is 10 nm to 200 nm.

12. An optical modulator, comprising:
the optical waveguide element according to claim 1;
a housing accommodating the optical waveguide element;
an input optical fiber connected to an optical input portion of the optical waveguide element; and
an output optical fiber connected to an optical output portion of the optical waveguide element.

13. The optical modulator according to claim 12, comprising, as the electrode, a modulation electrode that modulates light waves propagating through the optical waveguide, and having a signal amplification circuit inside the housing, which amplifies a modulation signal applied to the modulation electrode.

14. An optical transmission apparatus, comprising:
the optical modulator according to claim 13;
a light source inputting light waves to the optical modulator; and
a signal output circuit outputting the modulation signal.
